(19) United States
(12) Patent Application Publication
(10) Pub. No.: US 2014/0056634 A1
(43) Pub. Date: Feb. 27, 2014

(54) GLASS MARKER PENCIL

(71) Applicant: Kimberly DeBuhr, Rock Port, MO (US)

(72) Inventor: Kimberly DeBuhr, Rock Port, MO (US)

(21) Appl. No.: 13/595,958

(22) Filed: Aug. 27, 2012

(51) Int. Cl. B43K 8/02; B43K 8/24

(52) U.S. Cl. 401/99; 401/202

(57) ABSTRACT

A glass marker pencil utilized on a surface that includes a generally elongated shaped base market pencil with a top and a body, a tip that protrudes from the top of the base marker pencil, the tip is contained within the body of the base marker pencil, an ink contained in the tip and a cap placed over the tip to protect the tip. The tip can be a variety of different types of tips and the ink can be a variety of different types of inks that are non-toxic and made of glycerin color dye.

### TECHNICAL FIELD & BACKGROUND

Currently there are limited options for mediums that can effectively write on mirrored surfaces. Utilizing post-its, dry-erase markers and other common alternatives are often not resilient and tend to get lost or may be easily wiped-off of such writing backgrounds.

The present invention generally relates to a pencil. More specifically, the invention is a glass marker pencil.

It is an object of the invention to provide a glass marker pencil that allows a user to legibly write messages and other indicia on a glass surface that can be relatively easily removed.

It is an object of the invention to provide a glass marker pencil that allows a user to legibly write messages and other indicia on a refrigerator or any other non-porous surface that can be relatively easily removed.

It is an object of the invention to provide a glass marker pencil that is self-sharpening, utilizes a variety of colors and inks and can be retractable or twisted-up.

What is really needed is a glass marker pencil that allows a user to legibly write messages and other indicia on a glass surface that can be relatively easily removed that allows a user to legibly write messages and other indicia on a refrigerator or any other non-porous surface that can be relatively easily removed that is self-sharpening, utilizes a variety of colors and inks and can be retractable or twisted-up.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a side view of a glass marker pencil, according to an embodiment of the present invention.

FIG. 1B illustrates a front view of a surface utilized with a glass marker pencil, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

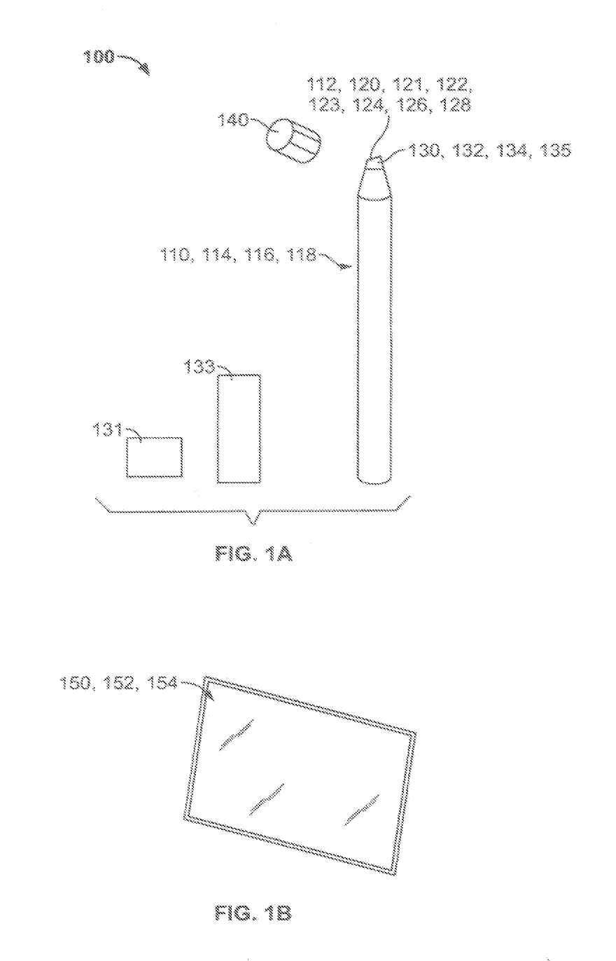

FIG. 1A illustrates a side view of a glass marker pencil 100, according to an embodiment of the present invention. The glass marker pencil 100 allows a user to legibly write messages and other indicia on a glass surface or a non-porous surface (FIG. 1B, 152,154) that can be relatively easily removed.

The glass marker pencil 100 includes a base marker pencil 110, a tip 120, an ink 130 and a cap 140. The base marker pencil 110 includes a top 112 and is generally elongated shaped 114 and has a body 116 that typically has a round shaped diameter 118, although the base marker pencil 110 can have a body 116 with other suitable shaped diameters as well such as a body with a square shaped diameter (not shown). The tip 120 protrudes from the top 112 of the base marker pencil 110 and is contained within the body 116 of the base marker pencil 110. The base marker pencil 110 is made of plastic but can be made of metal or any other suitable material. The tip 120 is a self-sharpening tip 122 and can be a retractable tip 124, a twist-up tip 126, a stationary tip 128 or any other suitable type of tip. The tip 120 can also be a sharpened tip 121, a rounded tip 123 or any other suitable shaped tip. The ink 130 is contained in the tip 120 and can include any suitable color such as red, black, green, blue or pink. The ink 130 is a non-toxic ink 135 and can be a sparkling ink 132, a glow-in-the-dark ink 134 or other suitable type of ink. The ink 130 is made of glycerin color dye but can be made of any other suitable chemical color dye. The ink 130 is relatively easily removable from a glass surface or a non-porous surface (FIG. 1B, 150,152) such as a mirror (not shown), a refrigerator (not shown) or other suitable glass surface or non-porous surface. The ink 130 is typically removed with a cloth 131 and a glass cleaner solution 133 that is wiped on the glass surface or the non-porous surface (FIG. 1B, 150,152) where the ink 130 is applied. The cap 140 is placed over the tip 120 to protect the tip 120 and to prevent the tip 120 from drying-out.

FIG. 1B illustrates a front view of a surface 150 utilized with a glass marker pencil 100, according to an embodiment of the present invention.

The surface 150 is a glass surface 152 or a non-porous surface 154. FIG. 1B illustrates a surface that can be a glass surface 152 or a non-porous surface 154, although the glass marker pencil 100 can be utilized on any suitable surface. The glass surface 152 can be a mirror or a window (both not shown). The non-porous surface 154 can be a refrigerator surface (not shown) or any other suitable non-porous surface. The ink 130 from the glass marker pencil 100 can be applied onto and removed from the glass surface 152 or the non-porous surface 154 relatively frequently without damaging the glass surface 152 or the non-porous surface 154.

The glass marker pencil is a non-toxic writing utensil that allows a user to leave messages, comments or information for recipients. Made from glycerin color dyes, the glass marker pencil has a pencil, marker or crayon design that can be self-sharpening and retractable or twist-up. With a choice of primary colors, sparkles and glow-in-the-dark dye, the glass marker pencil is able to leave clear markings on mirrors, windows and other slick surfaces for a relatively fun way to engage in written communication. The glass marker pencil may be readily available at stationary or arts and crafts retailers. The glass marker pencil cannot be removed without glass cleaner and does not jeopardize the integrity of the surface regardless of frequent use. The glass marker pencil features a non-toxic colorful writing medium, capable of writing on diverse transparent surfaces and affords adults and children with a different instrument of expression.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A glass marker pencil for writing on a glass surface, comprising:
an elongated base marker pencil with a top and a body, wherein said top is thinner than the body and the thickness of said elongated base marker pencil decreases near the point where the body contacts the top;
a tip which is disposed within said body of said base marker pencil and which protrudes from said top of said base marker pencil;
an ink contained in said tip; and
a cap configured to be placed over said tip to protect said tip.

2.-20. (canceled)
